(19) United States
(12) Patent Application Publication
(10) Pub. No.: US 2003/0058840 A1
(43) Pub. Date: Mar. 27, 2003

(54) In-line filter for combined telecommunication applications

(76) Inventor: Nathan G. Doose, Hanley Falls, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/094,375

(22) Filed: Mar. 8, 2002

Related U.S. Application Data
(60) Provisional application No. 60/274,203, filed on Mar. 8, 2001.

(51) Int. Cl. H04L 12/28

(52) U.S. Cl. 370/352; 370/351

(57) ABSTRACT

An in-line filter for use in telecommunication applications wherein both digital data signals and voiceband signals are transmitted on the same telecommunication medium. The inline filter includes an inductive circuit portion, a switchable RC network, and an RLC network. The inductive circuit portion is connected between a pair of ring and tip terminals. The switchable RC network is electrically coupled to the inductive circuit portion, as is the RLC network. The RC network is switchable between an “off-hook” state and an “on-hook” state. The off-hook state presents the RC network in parallel with the RLC network and, thereby, increases the capacitance across the ring and tip terminals. The on-hook state operationally, electrically removes the RC network from the filter and increases the impedance across the ring and tip terminals.

### RELATED APPLICATIONS

The present application claims priority to U.S. Provisional Patent Application No. 60/274,203, filed Mar. 8, 2001, and entitled “Microfilter”.

### FIELD OF THE INVENTION

The present invention relates to in-line filters and, more particularly, to an in-line filter for blocking high frequency digital subscriber line (DSL) signals from impedance variations of plain old telephone service (POTS) equipment.

### BACKGROUND OF THE INVENTION

The plain old telephone service (POTS) is the service that delivers analog voice signals to a user's home or office. These analog voice signals are generally transmitted at a frequency of less than 4 kHz. The same twisted pair of wires that carry the analog voice signals are also capable of carrying digital signals, albeit at higher frequencies than the analog voice signals, e.g., 25 kHz to 12 MHz. To enable operation of both POTS and a digital subscriber line (DSL), a splitter and/or filters are used to separate or adequately filter the analog and digital signals.

Depending on the type of DSL a splitter and/or filter may be required at both a remote location, i.e., the customer premise, and at the central office (CO) location. For example, with asymmetric DSL, or ADSL, both are required. In the instance of ADSL, the remote POTS splitter splits the incoming telephone signal into: (1) a low frequency signal for voice devices by utilizing an in-line filter; and (2) a high frequency data signal for computers. Meanwhile, the CO POTS splitter splits its incoming signal into: (1) a low frequency voice signal for the public switched telephone network (PSTN) by utilizing an in-line filter; AND (2) a high frequency signal for a DSL access multiplexor to direct the signal to the Internet.

To make voice and DSL widely available to the general public there is a need for the POTS splitters and/or filters at both the central office and at the customer premise to be cost-effective, of a minimally intrusive size, easily installed, as well as durable and reliable. POTS splitters are often installed on the exterior of a home whereby a DSL line and a POTS voice signal line separately enter the house. The POTS voice signal line can be split without further devices into as many telephones as necessary without any significant effect to the DSL line.

However, such installation of the exterior POTS splitter requires serviceperson installation. In many instances it is more convenient and more cost efficient to send equipment to the user for installation at an interior location. Devices suitable for such installation comprise in-line filters, which are also known as microfilters that are installed at each telephone or POTS device. Without the external (outside) POTS splitter, the DSL signal and the voice signal enter the customer premise on the same line introducing undesirable interactions that can degrade both the POTS performance and DSL performance. Examples of these undesirable interactions include: (1) reduction of the desired DSL signal amplitude due to low “off-hook” and/or “on-hook” POTS device impedance within the DSL band; (2) non-linear impedances of POTS devices causing translation of the DSL signal energy to undesired frequency bands through intermodulation distortion (IMD) products; (3) ingress of DSL signals into POTS devices causing audible POTS interference through nonlinear interactions inside the POTS device; (4) DSL band impedance differences when POTS devices are “on-hook” or “off-hook”; and (5) un-terminated wire stubs causing deep nulls in the in-premises phoneline network frequency band resulting in the impairment of the operation of the in-premises phoneline network.

### SUMMARY OF THE INVENTION

The present invention comprises an in-line filter for use in telecommunication applications wherein both digital data signals and voiceband signals are transmitted on the same telecommunication medium. The in-line filter includes an inductive circuit portion, a switchable RC network, and an RLC network. The inductive circuit portion is connected between a pair of ring and tip terminals. The switchable RC network is electrically coupled to the inductive circuit portion, as is the RLC network. The RC network is switchable between an “off-hook” state and an “on-hook” state. The off-hook state presents the RC network in parallel with the RLC network and, thereby, increases the capacitance across the ring and tip terminals. The on-hook state operationally, electrically removes the RC network from the filter and increases the impedance across the ring and tip terminals.

The off-hook state described above results in an increase in the roll-off of the filter. In a preferred embodiment of the filter, the inductive circuit portion consists of a first inductor in series with a second inductor. Further, the switchable RC network is preferably switched by a reed switch. Note that the filter may additionally include a voltage protector that is electrically coupled to the RC network, the voltage protector protecting the reed switch from transients during the on-hook state.

The present invention additionally comprises a method for filtering a combined signal transmission, i.e., voiceband signals and digital data signals, carried on a single transmission medium. The method of filtering includes the steps of: (1) presenting an inductive circuit portion to the signal; (2) switching in an RC network upon a current passing through the inductive circuit, the switching in operating to electrically couple the RC network to the inductive circuit portion and to an RLC network; and (3) switching out the RC network when the current is not passing through the inductive circuit portion, the switching out operating to electrically decouple the RC network from the inductive circuit portion while allowing the RLC network to remain electrically coupled to the inductive circuit portion.

With regard to the method above, the RC network is present in parallel with the RLC network upon being switched in. The switching is preferably achieved through use of a reed switch that is in series with the RC network. Note that the switching out of the RC network results in increased filter output impedance.

The present invention additionally includes an alternative embodiment of the in-line filter wherein performance is optimized through use of a minimal number of inexpensive and readily available components. Specifically, the alternative embodiment of the in-line filter consists only of a first bobbin core inductor that is connected between a ring input terminal and a ring output terminal, a second bobbin core inductor that is connected between a tip input terminal and a tip output terminal, and a capacitor. The capacitor operates to electrically connect the first and second bobbin core inductors as well as the ring and tip output terminals.

### BRIEF DESCRIPTION OF THE DRAWINGS

FIG. 1 is a block diagram of a telecommunication system for interconnecting a central office and a customer's premise employing the in-line filter of the present invention.

FIG. 2 is a circuit diagram of the in-line filter of the present invention.

FIG. 3 provides a depiction of a typical mechanical layout of the in-line filter of the present invention.

FIG. 4 is a circuit diagram of an alternative embodiment of the in-line filter of the present invention.

FIG. 5 provides a depiction of a typical mechanical layout of the alternative embodiment of the in-line filter of the present invention.

FIGS. 6A-6D are circuit diagrams of prior art in-line filters whose operation is compared with that of the alternative embodiment of the in-line filter of the present invention.

### DETAILED DESCRIPTION OF THE PREFERRED EMBODIMENTS

The present invention comprises an in-line filter for use in digital subscriber line (DSL) applications. The filter operates to block the high frequency DSL signal from impedance variations of plain old telephone service (POTS) equipment. The in-line filter of the present invention is designed per the T1E1.4/2001-007R3 specifications, an in-line filter standard submitted for adoption by the American National Standards Institute (ANSI). The identified standard is hereby incorporated by reference.

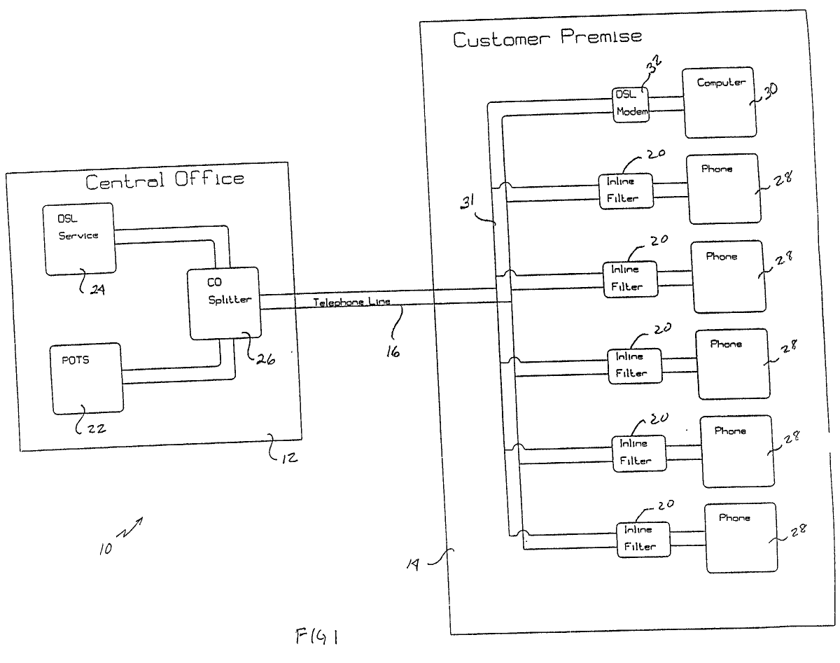

Referring to FIG. 1, a block diagram of an example configuration of a telecommunication system 10 for interconnecting a telephone company's central office 12 and a customer's premise 14 over a transmission media, such as a conventional twisted pair of telephone lines 16, is presented. The telecommunication system 10 incorporates a plurality of in-line filters 20 of the present invention.

The central office 12 includes a POTS service 22 and a DSL service 24 which are delivered over telephone line 16. The central office 12 additionally includes a splitter 26 for incoming transmissions, the splitter 26 operating to split the transmission into: (1) a low frequency voice signal, i.e., POTS; and (2) a high frequency data signal, i.e., DSL. The customer premise 14 includes a plurality of POTS devices 28, e.g., phones, and each of the POTS devices 28 is provided with an in-line filter 20 of the present invention. The customer premise 14 additionally includes DSL devices 30, e.g., a computer with digital modem 32. Each of the devices 28 and 30 are connected to an in-premise phoneline network 31 and ultimately to telephone line 16.

As shown by FIG. 1, without the use of in-line filters 20 of the present invention, the output impedance from each of the POTS devices 28 would be connected in parallel with the input impedance of the DSL device 30. The output impedances of the POTS devices 28 are most often subject to wide variations from changing states between “on-hook” (no current flowing) to “off-hook” (current flowing). The quickly changing current flow and corresponding changing impedance can significantly affect the delivery of DSL data signals. To counteract this changing impedance, the in-line filter 20 of the present invention is used.

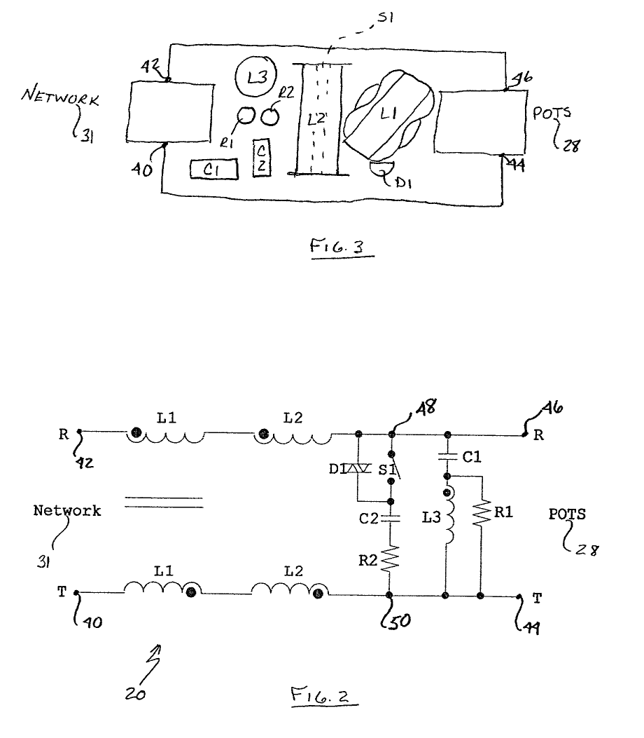

A circuit diagram of in-line filter 20 is provided in FIG. 2. The filter 20 is a 2-pole elliptical design created per T1E1.4/2001-007R3, as noted above. The filter 20 preferably includes the components listed in Table 1. It should be noted that other component values may be used without departing from the spirit or scope of the invention.

TABLE 1

| Component Name/ | |
|---|---|
| Value | Component Type |
| L1/3-6 mH | Inductor, RM6 structure with an initial permeability |
| | of 2000 |
| L2/0.5-2 mH | Inductor, Air core structure |
| L3/0.5-1.5 mH | Inductor, Bobbin core structure with an initial |
| | permeability of 400 |
| C1/8-12 nF | Capacitor, Metallized polyester film |
| C2/22-39 nF | Capacitor, Metallized polyester film |
| R1/200-300 Ohms | Resistor, Metal film |
| R2/25-100 Ohms | Resistor, Metal film |
| S1/7-15 A/T | Reed Switch, 7-15 AT |
| D1/140-180 V | Voltage Protection varistor |

As shown in FIG. 2, in-line filter 20 includes two input (tip and ring) terminals 40 and 42 which are connectable to the in-premise phoneline network 31, as well as two output (tip and ring) terminals 44 and 46 that are connectable to POTS device 28. Inductors L1 and L2 are connected in series between terminals 42 and 46 and likewise between terminals 40 and 44. Common nodes 48 and 50 connect the series components S1, C2, and R2 to inductor L2 and terminals 46 and 44. Varistor D1 is connected in series with C2 and R2, and in parallel with reed switch S1 to protect reed switch S1 from being damaged by transients when the POTS device 28 is in its “on-hook” (no current flowing) stage. Also connected between common nodes 48 and 50 is the series of capacitor C1 and inductor L3. Resistor R1 is provided in parallel with inductor L3.

When current is flowing through the in-line filter 20, i.e., the POTS device 28 is in the “off-hook” state, the magnetic field created by L2 causes the reed switch S1 to close. With reed switch S1 closed, the RC network of capacitor C2 and resistor R2 is placed in parallel with the RLC network of capacitor C1, inductor L3 and resistor R1. This increases the total capacitance across the tip and ring, thus increasing the filter roll-off, i.e., the point at which the filter 20 begins to attenuate. When no current is flowing in the circuit, i.e., the POTS device 28 is in the “on-hook” state, the reed switch S1 is open, which disconnects capacitor C2 and resistor R2 from the circuit. This causes the roll-off to be worse, but increases the voiceband impedance of the filter. The increase of impedance is needed when multiple filters 20 are connected across a telephone line.

To explain further, as each additional filter 20 is added to a telephone line, the impedance presented to the voiceband signal lowers due to parallel loading effects of the filters 20. The lower the parallel impedance is, the more the voiceband signal is attenuated, thus causing degradation in telephone service.

The values of the components that are needed to create a filter roll-off (stopband attenuation) that meets the T1E1 specifications for off-hook performance creates too low of an impedance across the voiceband signal when multiple filters are used. This impedance can be increased by altering the component values, but will then degrade the stopband attenuation.

The stopband attenuation defined in the T1E1 document allows for a more gradual roll-off in the on-hook state and requires a sharper roll-off for the off-hook state. This specification enables the use of a reed switch to add the RC network of C2 and R2 to the circuit when current is flowing (off-hook condition) which causes the filter to have a sharp roll-off, but a lower impedance to the vioceband signals. When there is no current flowing through the circuit (on-hook condition), the RC network of C2 and R2 is removed from the circuit. This will degrade the roll-off of the filter, but will increase its impedance to the voiceband signal. By design, this allows the filter in use (off-hook) to have the required roll-off while the other filters not in use (on-hook) are allowed to present higher impedance to the voiceband signal. This configuration results in less overall attenuation in the voiceband frequencies caused by filtering.

The design of the filter 20 is not only able to meet the T1E1 specifications but also provides the advantage of presenting a low DC resistance. Additionally, the design, through the use of a minimum number of filter poles, results in a low component count for the filter circuit.

FIG. 3 depicts a mechanical layout of the in-line filter 20 of the present invention with circuit components labeled in correspondence with the circuit diagram of FIG. 2.

Alternative Embodiments

An alternative embodiment of filter 20 is shown in FIG. 4 and utilizes a minimal number of components. While the embodiment of FIG. 4 does not meet T1E1.4/2001-007R3 standards, it is an effective in-line filter operating to perform the function of blocking the high frequency DSL signal from impedance variations of POTS equipment. The filter 20 of FIG. 4 does not incorporate the reed switch S1, described in the earlier embodiment above, but rather comprises only those components that are listed in Table 2. It should be noted that other component values may be used without departing from the spirit or scope of the invention.

TABLE 2

| Component Name/ | |
|---|---|
| Value | Component Type |
| L1/10-15 mH | Inductor, bobbin core structure, permeability of 400 |
| L2/10-15 mH | Inductor, bobbin core structure, permeability of 400 |
| C1/15-33 nF | Capacitor, Metallized polyester film |

The filter 20 of FIG. 4 includes two input (tip and ring) terminals 40 and 42 which are connectable to the in-premise phoneline network 31, as well as two output (tip and ring) terminals 44 and 46 that are connectable to POTS device 28. A first inductor L1 is connected between terminals 42 and 46 and a second inductor L2 is connected between terminals 40 and 44. A capacitor C1 connects inductor L1 and inductor L2.

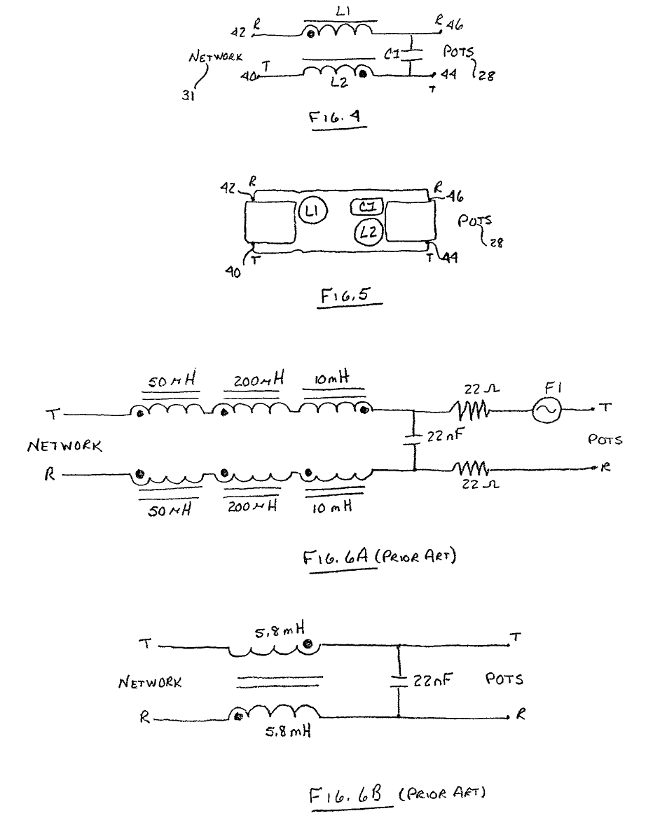

The filter 20 of the present embodiment preferably uses two bobbin core structures, which are inexpensive and readily available. Since no separate bobbin is needed, the wire of the inductor can be wound directly onto the ferrite material for ease of construction. A mechanical layout of the filter 20 of the present embodiment is provided in FIG. 5, common notation providing the correlation with FIG. 4.

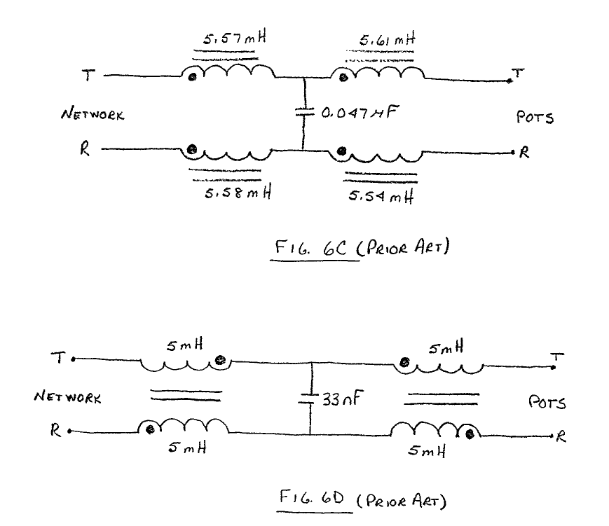

The performance of filter 20 of the present embodiment was compared against four other prior art filters, which are depicted in FIGS. 6A-6D. A summary of the type and number of the components that are preferably used to implement each of the filters is provided in Table 3.

TABLE 3

| Mfg. | Type | Bobbins | Toroids | Fuses | Caps. | Res. | EPs | Total | Direction |
|---|---|---|---|---|---|---|---|---|---|
| Sub- | 2 Pole | 2 | 0 | 0 | 1 | 0 | 0 | 3 | Single |
| ject | Butterworth | | | | | | | | |
| A | 2 Pole | 4 | 2 | 1 | 1 | 2 | 0 | 10 | Single |
| | Butterworth | | | | | | | | |
| B | 2 Pole | 0 | 0 | 0 | 1 | 0 | 1 | 2 | Single |
| | Butterworth | | | | | | | | |
| C | 3 Pole | 4 | 0 | 0 | 1 | 0 | 0 | 5 | Bi |
| | Chebychev | | | | | | | | |
| D | 3 Pole | 0 | 0 | 0 | 1 | 0 | 2 | 3 | Bi |
| | Chebychev | | | | | | | | |

As can be seen from Table 3, comparison filter C employs a total of four bobbin core inductors and a capacitor. Comparison filter A uses a combination of toroids and bobbin cores with a total of six inductors and a capacitor. The comparison filter D and comparison filter B use expensive EP style core structures. These cores are more costly than toroids or bobbin cores, and use an additional plastic bobbin winding; a cut-in air gap is also required to help withstand the DC bias that is conducted through the filter.

The filter 20 of the present embodiment, the comparison filter A, and the comparison filter B are 2-pole Butterworth filters making them comparable in insertion loss testing. The comparison filter D and the comparison filter C are 3-pole Chebychev filters; the chebychev design adds another inductor set into the filter allowing the filter to be placed in a circuit in any direction and giving it a sharper stopband rolloff.

When various insertion loss tests were performed on the filter 20 of the present embodiment and on the comparison filters, the results showed that the filter 20 of the present embodiment, comparison filter A, and comparison filter B had similar performance characteristics. The comparison filter D and comparison filter C resulted in a sharper rolloff than either the filter 20 of the present embodiment or comparison filter A, but comparison filter D and C did not perform as well when multiple filters were paralleled together.

Note that the insertion loss tests that were performed included: 1. 600:600 Ohm test setup (attenuation distortion) to cover the entire DSL frequency spectrum from 200 Hz to 12 MHz. Each filter was tested with and without DC bias (100 mA) applied as well as with 3, 4, and 7 filters in parallel. The parallel testing was performed to simulate loading effects of multiple filters on the voiceband (200 Hz-4 kHz); 2. 100:100 Ohm test setup (bridging loss) used to determine the loss created in the data frequencies (25 kHz-12 MHz) with and without DC bias (100 mA); 3. 100-Ohm:<250 kOhm test setup (high band testing) used to test the attenuation of the filter in the high frequency band (25 kHz-10 MHz) with and without DC bias (100 mA).

The filter 20 of the present embodiment provides an optimal and surprising combination of performance characteristics, minimal number of components, use of low cost components and ease of fabrication.

The present invention may be embodied in other specific forms without departing from the spirit of the essential attributes thereof, therefore, the illustrated embodiments should be considered in all respects as illustrative and not restrictive, reference being made to the appended claims rather than to the foregoing description to indicate the scope of the invention.

What is claimed:

1. An in-line filter for use in telecommunication applications wherein digital data signals and voiceband signals are transmitted on the same medium, the filter comprising:
an inductive circuit portion connected between a pair of ring and tip terminals;
a switchable RC network electrically coupled to said inductive circuit portion; and
an RLC network electrically coupled to said inductive circuit portion, wherein said switchable RC network switches between an “off-hook” state and an “on-hook” state, said “off-hook” state placing said switchable RC network in parallel with said RLC network to increase a capacitance across said ring and tip terminals, and said “on-hook” state electrically removing said RC network from said in-line filter to increase an impedance across said ring and tip terminals.

2. The filter of claim 1, wherein said “off-hook” state increases a roll-off of said filter.

3. The filter of claim 1, wherein said inductive circuit portion comprises a first inductor and a second inductor connected in series.

4. The filter of claim 1, wherein said inductive circuit portion consists of a first inductor and a second inductor connected in series.

5. The filter of claim 1, wherein said switchable RC network includes a reed switch.

6. The filter of claim 1, further comprising a voltage protector that is electrically coupled to said switchable RC network.

7. The filter of claim 5, wherein said voltage protector protects said reed switch from a transient in said “on-hook” state.

8. An in-line filter for use in telecommunication applications wherein digital data signals and voiceband signals are transmitted on the same medium, the filter comprising:
a first inductor and a second inductor connected in series between a pair of ring and tip terminals;
an RC network electrically coupled to said second inductor, said RC network capable of being operationally, electrically inserted and operationally, electrically removed from said filter through use of a reed switch; and
an RLC network electrically coupled to said second inductor, wherein upon said reed switch operationally, electrically inserting said RC network into said filter, said RC network is electrically coupled in parallel with said RLC network to increase a capacitance across said ring and tip terminals.

9. The filter of claim 8, wherein upon said RC network being electrically inserted within said filter a roll-off of said filter is increased.

10. The filter of claim 8, wherein upon said reed switch operationally, electrically removing said RC network from said filter an impedance across said ring and tip terminals is increased.

11. The filter of claim 8, further comprising a voltage protector that is electrically coupled in parallel with said reed switch.

12. The filter of claim 11, wherein said voltage protector protects said RC network from a transient when said RC network is operationally, electrically removed from said filter by said reed switch.

13. An in-line filter for use in telecommunication applications wherein digital data signals and voiceband signals are transmitted on the same medium, the filter comprising:
a first inductor connected to a first pair of ring and tip terminals;
a second inductor connected in series to said first inductor and to a second pair of ring and tip terminals;
a reed switch connected to said second inductor and to a first capacitor, connected in series with a first resistor; and
a second capacitor connected to said second inductor and to a third inductor, said third inductor in parallel with a second resistor.

14. The filter of claim 13, further comprising a voltage protector in parallel with said reed switch.

15. The filter of claim 13, wherein a current flowing through said filter creates a magnetic field about said second inductor causing said reed switch to close and present said first capacitor and said first resistor in parallel with said second capacitor, third inductor and second resistor.

16. The filter of claim 15, wherein upon said reed switch closing a roll-off of said filter is increased.

17. The filter of claim 13, wherein upon a current being absent from said filter, said reed switch is open.

18. The filter of claim 17, wherein upon said reed switch being op en, said first resistor and said first capacitor are operationally, electrically removed from said filter.

19. The filter of claim 18, wherein upon said first resistor and said first capacitor being operationally, electrically removed from said filter, an impedance across said ring and tip terminals is increased.

20. The filter of claim 15, wherein upon a current being absent from said filter, said reed switch is open.

21. A method for filtering signals carried on a transmission medium, wherein said signals comprise digital data signals and voiceband signals, said method comprising the steps of:
presenting an inductive circuit portion to the signal;
switching in an RC network upon a current passing through said inductive circuit portion, upon switching in said RC network, said RC network electrically coupled to said inductive circuit portion and to an RLC network; and
switching out said RC network upon said current not passing through said inductive circuit portion, upon switching out said RC network, said RC network electrically decoupled from said inductive circuit portion, said RLC network remaining electrically coupled to said inductive circuit portion.

22. The method of claim 21, wherein said RLC network is in parallel with the switched in RC network.

23. The method of claim 21, wherein said step of switching is performed by a reed switch.

24. The method of claim 21, wherein said RC network comprises a capacitor in series with a resistor.

25. The method of claim 21, wherein said RLC network comprises a capacitor in series with a parallel combination of a resistor and an inductor.

26. The method of claim 21, wherein said inductive circuit portion comprises a first inductor in series with a second inductor.

27. The method of claim 21, wherein said inductive circuit portion consists of a first inductor in series with a second inductor.

28. The method of claim 21, wherein upon said step of switching in occurring a roll-off of said filter is increased.

29. The method of claim 21, wherein upon said step of switching out occurring an output impedance of said filter is increased.

30. An in-line filter for use in telecommunication applications wherein digital data signals and voiceband signals are transmitted on the same medium, the filter consisting of:
a first bobbin core inductor connected between a ring input terminal and a ring output terminal;
a second bobbin core inductor connected between a tip input terminal and a tip output terminal;
and a capacitor, wherein said capacitor electrically connects said first and second bobbin core inductors, and electrically connects said ring and tip output terminals.

31. The filter of claim 30, wherein the bobbin core of said first and second bobbin core inductors comprises ferrite.

32. The filter of claim 31, wherein the ferrite bobbin core of said first and second bobbin core inductors has a permeability of approximately 400.

33. An in-line filter for use in telecommunication applications wherein digital data signals and voiceband signals are transmitted on the same medium, the filter consisting of:
a two-pole butterworth filter inserted between a ring and tip input and a ring and tip output, said two-pole butterworth filter having a maximum of three components selected from a group consisting of: inductive components and capacitive components.

34. The filter of claim 33, wherein said inductive components are bobbin core structures.

35. The filter of claim 33, wherein said maximum of three components comprise a first inductor, a second inductor, and a capacitor.

36. The filter of claim 35, wherein said first inductor and said second inductor comprises bobbin core inductors.

37. The filter of claim 34, wherein said bobbin core structure comprises ferrite.

38. The filter of claim 37, wherein said bobbin core structure has a permeability of approximately 400.
